(19) United States
(12) Patent Application Publication
(10) Pub. No.: US 2022/0348801 A1
(43) Pub. Date: Nov. 3, 2022

(54) MODIFIED HYDROXYPROPYL METHYL CELLULOSE FOR ENHANCED CERAMIC TILE ADHESIVE AND PREPARATION METHOD AND APPLICATION THEREOF

(71) Applicant: SHANDONG ETON NEW MATERIAL CO., LTD, Tai'an (CN)

(72) Inventors: Kun Teng, Tai'an (CN); Ming Zhao, Tai'an (CN); Bo Teng, Tai'an (CN); Qinghua Li, Tai'an (CN); Aimei Jiang, Tai'an (CN); Jianyu Zhao, Tai'an (CN); Zhaowu Meng, Tai'an (CN)

(21) Appl. No.: 17/867,659

(22) Filed: Jul. 18, 2022

Related U.S. Application Data
(63) Continuation of application No. PCT/CN2021/086759, filed on Apr. 13, 2021.

(30) Foreign Application Priority Data
Jul. 9, 2020 (CN) 202010657589.8

(51) Int. Cl. C09J 101/28; C09J 11/08; C08B 11/193

(52) U.S. Cl. CPC C09J 101/284; C09J 11/08; C08B 11/193

(57) ABSTRACT

The present disclosure discloses a modified hydroxypropyl methyl cellulose for an enhanced ceramic tile adhesive, which is prepared from the following raw materials by mass percent: 54%-94% of hydroxypropyl methyl cellulose, 5%-40% of starch ether, 0.5%-3% of dispersing agent and 0.5%-3% of rheological agent, wherein the hydroxypropyl methyl cellulose is prepared from cellulose powder, granular caustic soda, liquid caustic soda, chloromethane and propylene oxide. A preparation method includes: (1) weighing the raw materials; (2) mixing the cellulose powder, the granular caustic soda, the liquid caustic soda, the chloromethane and the propylene oxide, carrying out etherification reaction, and then sequentially carrying out neutralization, washing, centrifugation, drying and crushing to obtain the hydroxypropyl methyl cellulose; and (3) mixing and stirring the hydroxypropyl methyl cellulose, the starch ether, the dispersing agent and the rheological agent to obtain the modified hydroxypropyl methyl cellulose.

### TECHNICAL FIELD

The present disclosure relates to the technical field of building materials, in particular to a modified hydroxypropyl methyl cellulose for an enhanced ceramic tile adhesive and a preparation method and application thereof.

### BACKGROUND

As a decorative material, ceramic tiles have a broad market. However, with the increasing specialization of the ceramic tile market, more and more customers are pursuing the seamless effect of wall decoration, which makes large-sized ceramic tiles more and more popular. At the same time, the increasing popularity of large-area residential buildings also promotes the popularity of the large-sized ceramic tiles. With the increasing size and mass of the ceramic tiles, the requirements for safety are higher and higher, and the traditional ceramic tile adhesive has been difficult to meet the requirements, so novel ceramic tile adhesives have been developed rapidly.

Main causes of the falling-off of the ceramic tile are: (1) shrinkage deformation of a new concrete foundation layer; (2) external factors, such as building settlement and creepage; (3) deformation caused by the sudden change of temperature; (4) shear stress produced by the moisture expansion of porous ceramic tiles; and (5) smooth surfaces of the ceramic tiles causing small mechanical anchoring force between the adhesive and the ceramic tile, leading to small stress caused by other reasons, resulting in the damage of cohesion. In view of these problems, the conventional ceramic tile adhesive can only meet some requirements, but for the vitrified tiles with larger area, such as 600 mm×600 mm or more, because of the large shrinkage rate, the conventional ceramic tile adhesive used to paste the high-quality ceramic tiles often has the phenomena of hollowing and tile falling-off. Therefore, an enhanced ceramic tile adhesive is required to paste the high-quality ceramic tiles.

Hydroxypropyl Methyl Cellulose (HPMC) is a kind of cellulose mixed ether with rapid increase in yield, consumption and quality in recent years. HPMC is a nonionic cellulose mixed ether made from cotton and wood through alkalization, etherification of propylene oxide and methyl chloride, etc. A molecular structure of HPMC is [C₆H₇O₂(OH)₃₋ₘ₋ₙ (OCH₃)ₘ(OCH₂CHOHCH₃)ₙ]ₓ. At present, the production technology of the HPMC may be classified into two categories: a liquid phase method and a gas phase method. The internal pressure of equipment used in the liquid phase method is low, which requires low pressure-bearing capacity of the equipment and is less dangerous. After the cellulose is soaked in alkali liquor, the alkali cellulose can be fully swelled and alkalized uniformly. The alkali liquor can permeate and swell the cellulose well, so that products with uniform degree of substitution and viscosity can be obtained, and the variety of the products is easy to change. However, a reactor cannot have an excessively large size (generally less than 15 m³), so that the production capacity is small. If the yield is to be increased, more reactors may be added, and a large number of organic solvents may be needed as carriers in the reaction process. The reaction time is relatively long (generally more than 10 hours), which increases the distillation recycling and time cost of the solvent. The gas phase method has compact equipment and high single batch yield. The reaction is carried out in a horizontal autoclave, and the reaction time (generally 5-8 hours) is less than that of the liquid phase method. Moreover, a complex solvent recycling system is not needed. After the reaction is finished, the surplus chloromethane and byproduct dimethyl ether enter the recycling system in a gaseous form to be recycled separately, so that the labor cost is low, the labor intensity is small, and the production cost is less than that of the liquid phase method. However, the investment on the equipment and automatic control is high, the technical skill is high, and the investment and construction cost are high.

Therefore, how to provide a modified hydroxypropyl methyl cellulose for an enhanced ceramic tile adhesive and a preparation method thereof is an urgent problem to be solved by the technical skilled in the art.

### SUMMARY

In order to overcome the defects of the prior art, the present disclosure provides a modified hydroxypropyl methyl cellulose for an enhanced ceramic tile adhesive and a preparation method and application thereof, which changes the complicated operation of multi-step etherification in the preparation of the existing modified hydroxypropyl methyl cellulose, and only needs one-step etherification through the control of special operating conditions. And because physical modification steps are added continuously, products with better performance are obtained, and the tensile bonding strength of the ceramic tile adhesive is improved significantly. At the same time, the operating conditions of the one-step etherification differ significantly from the prior art in that under the condition that no inhibitor dimethyl ether is added, the alkali concentration of the system is increased by adding granular caustic soda, and the etherification efficiency of the etherifying agent is increased. At the same time, the etherification reaction is carried out at different pressure stages and implemented under higher pressure, so that the uniformity of the product is improved, and the etherification efficiency of the etherifying agent is further increased. And moreover, the production cost is reduced on the premise of not increasing the reaction time, and the problems in the prior art are solved.

To realize the above purpose, the present disclosure adopts the following technical solution.

The modified hydroxypropyl methyl cellulose for the enhanced ceramic tile adhesive is prepared from the following raw materials by mass percent: 54%-94% of hydroxypropyl methyl cellulose, 5%-40% of starch ether, 0.5%-3% of dispersing agent and 0.5%-3% of rheological agent. The hydroxypropyl methyl cellulose is prepared from cellulose powder, granular caustic soda, liquid caustic soda, chloromethane and propylene oxide in a mass ratio of 1:(0.01-1.0):(0.02-2.1):(0.50-2.0):(0.01-1.5); and preferably the hydroxypropyl methyl cellulose is prepared from cellulose powder, granular caustic soda, liquid caustic soda, chloromethane and propylene oxide in a mass ratio of 1:(0.1-0.7):(0.1-1.0):(0.55-1.7):(0.05-1.2).

Further, the starch ether is any one or mixture of more of monobasic starch ether (with one substituent, such as carboxymethyl starch, hydroxypropyl starch, hydroxyethyl starch, etc.), binary starch ether (with two substituents, such as carboxymethyl hydroxypropyl starch, hydroxypropyl hydroxyethyl starch, carboxymethyl hydroxyethyl starch, etc.), and ternary starch ether (with three substituents, such as carboxymethyl hydroxypropyl hydroxyethyl starch, hydroxypropyl hydroxyethyl ethyl starch, hydroxypropyl hydroxyethyl methyl starch, etc.).

By adopting the above technical solution, the present disclosure further has the beneficial effects that the starch ether in the present disclosure has a function of improving the slip resistance of the ceramic tile adhesive and prolonging the open time of the ceramic tile adhesive. The starch ether selected in the present disclosure contains various hydrophilic groups, which increases the content of the branch-chain substituent groups, and can be synergistic directly with a straight-chain structure of the hydroxypropyl methyl cellulose, thereby improving the moisture retaining capacity of the ceramic tile adhesive, and prolonging the open time. And at the same time, the various branch-chain substituents of the starch ether increase the steric hindrance of the ceramic tile adhesive, and improve the slip resistance of the ceramic tile adhesive.

Further, the above dispersing agent is any one or mixture of more of polyacrylamide, polyvinyl alcohol and polyethylene oxide, and preferably is any one or mixture of more of anionic polyacrylamide, nonionic polyacrylamide, polyvinyl alcohol and polyethylene oxide.

By adopting the above technical solution, the present disclosure further has the beneficial effect that the dispersing agent has a function of improving the bonding strength of the ceramic tile adhesive. The dispersing agent selected in the present disclosure has excellent water solubility and good compatibility with cellulose ether, which can improve the water retaining capacity of cement slurry, also can improve the convey ability greatly, and can inhibit the flying of the dust, thereby improving the production environment.

Further, the rheological agent is any one or mixture of more of guar gum, Arabic gum, carrageenan and xanthan gum.

By adopting the above technical solution, the present disclosure further has the beneficial effect that the rheological agent has functions of regulating the viscosity of the product and synergistically improving the stability of the slurry together with other components. The rheological agent selected in the present disclosure has excellent water solubility and good compatibility with cellulose ether, which can improve the water retaining capacity of the cement slurry, and enhance the stability to heat, acid, alkali, enzyme and salt.

Further, the cellulose powder is any one or mixture of more of cotton cellulose, wood cellulose, bamboo cellulose and straw cellulose, preferably is any one or mixture of more of cotton cellulose, wood cellulose and bamboo cellulose, and more preferably is cotton cellulose and/or wood cellulose, and is still more preferably cotton cellulose. The polymerization degree of the cellulose powder is 500-8000, preferably 1000-5000, and more preferably 2400-3000. A particle size of the cellulose powder is 0.18-0.30 mm, and preferably 0.212-0.250 mm. And the bulk density of the cellulose powder is 150-200 g/L.

By adopting the above technical solution, the present disclosure further has the beneficial effect that the cellulose powder is a macromolecular straight-chain structure as a main reaction raw material of the cellulose ether and has a function of retaining the moisture. The cellulose powder selected in the present disclosure is a pollution-free and renewable resource, and is vast in reserve and easy to prepare. The selected polymerization degree range has good reaction property, and the reaction post-treatment is smooth. The selected particle size is easy to permeate in the reaction system, the reaction efficiency is high, and the discharge is smooth. And the selected bulk density is uniform in dispersion in the reaction system, and easier in mass transfer and heat transfer, and the reaction efficiency is high.

Further, the granular caustic soda is granular alkali metal hydroxide. The alkali metal hydroxide is preferably sodium hydroxide and/or potassium hydroxide, and more preferably sodium hydroxide. And the particle size of the granular caustic soda is 0.3-2.0 mm, preferably 0.4-1.5 mm, and more preferably 0.5-1.0 mm.

By adopting the above technical solution, the present disclosure further has the beneficial effects that the granular caustic soda has functions of increasing the concentration of alkali liquor and increasing the reaction speed. The granular caustic soda selected in the present disclosure is easy to dissolve in water, has high solubility and dissolving speed and can shorten the alkalization time. And the particle size selected in the present disclosure has good flowability, and is convenient in operation, unlikely to produce dust and rapid to dissolve.

Further, the liquid caustic soda is an aqueous solution of alkali metal hydroxide. The alkali metal hydroxide is preferably sodium hydroxide and/or potassium hydroxide, and more preferably sodium hydroxide. And the mass concentration of the alkali metal hydroxide in the liquid caustic soda is 40%-60%, preferably 45%-55%, more preferably 48%-52%, and still more preferably 50%.

By adopting the above technical solution, the present disclosure further has the beneficial effect that water in the liquid caustic soda in the present disclosure is used as the reaction dispersing agent, which makes the reaction of materials more uniform and improves the product quality. And alkali in the liquid caustic soda has a function of activating hydroxyl in the cellulose molecules, so that the cellulose is converted into alkaline cellulose to perform the subsequent etherification reaction. The liquid caustic soda selected in the present disclosure has high solubility. And the liquid caustic soda with the mass concentration selected in the present disclosure is good in flowability at the room temperature, which facilitates the pumping. And at the same time, the liquid caustic soda is high in concentration, the reaction efficiency of the system is high, and the utilization rate of the etherifying agent can be increased.

A preparation method of the modified hydroxypropyl methyl cellulose for the enhanced ceramic tile adhesive specifically includes the following steps.

(1) The raw materials according to a mass ratio of the modified hydroxypropyl methyl cellulose for the enhanced ceramic tile adhesive are weighed.

(2) The cellulose powder, the granular caustic soda, the liquid caustic soda, the chloromethane and the propylene oxide are mixed, first-stage etherification reaction and second-stage etherification reaction are carried out sequentially, and then neutralization, washing, centrifugation, drying and crushing are carried out sequentially to obtain the hydroxypropyl methyl cellulose.

(3) The hydroxypropyl methyl cellulose, the starch ether, the dispersing agent and the rheological agent are mixed and stirred to obtain the modified hydroxypropyl methyl cellulose for the enhanced ceramic tile adhesive.

Further, in the step (2), the first-stage etherification reaction is carried out under the pressure of 1.8-2.0 MPa and at the temperature of 55-65° C., and the reaction time is 0.5-1.5 h. The second-stage etherification reaction is carried out under the pressure of 2.3-2.5 MPa and at the temperature of 75-85° C., and the reaction time is 0.5-1.5 h.

By adopting the above technical solution, the present disclosure further has the beneficial effect as follows. The first-stage etherification reaction is carried out under the pressure of 1.8-2.0 MPa, which is more conducive to the reaction of propylene oxide, and increases the etherification efficiency of the propylene oxide. The second-stage etherification reaction is carried out under the pressure of 2.3-2.5 MPa, which is more conducive to the reaction of the chloromethane, and increases the etherification efficiency of the chloromethane. By adopting the reaction way in two pressure stages, the reaction uniformity is increased. Meanwhile, due to the high reaction pressure, the etherification efficiency is increased, and the reaction time of the two pressure stages is shortened, so that the total etherification reaction time is kept within 3 h, the production efficiency is increased, and the production cost is reduced. And at the same time, the whole reaction process is carried out in the reactor with pressure resistance of 2.8-3.5 MPa, thereby guaranteeing the reaction safety.

Further, in the step (2), after the etherification reaction is ended, the preparation method further includes the following operating steps. The non-reacted etherifying agent is recycled through a three-stage condensation recycling process, wherein at the first stage, the condensation recycling is carried out by directly relieving the pressure, and the pressure of the reactor decreases from 2.3-2.5 MPa to 0.75-1.1 MPa; at the second stage, the condensation recycling is carried out by compression, and the pressure of the reactor decreases from 0.75-1.1 MPa to 0.1-0.25 MPa; and at the third stage, the condensation recycling is carried out through vacuum and compression, and the pressure of the reactor decreases from 0.1-0.25 MPa to (−0.08)-(−0.1) MPa.

By adopting the above technical solution, the present disclosure further has the beneficial effect that by adopting the recycling way of the etherifying agent in the present disclosure, the consumption of the etherifying agent can be reduced, so that the pressure relief process of the autoclave is smoother, safer and more environment-friendly. And at the same time, the etherifying agent is recycled for use, so that the utilization rate of the etherifying agent is increased, and the production cost is reduced.

Further, in the step (2), the neutralization process is as follows: acetic acid and/or hydrochloric acid is added to regulate the pH of the material to be 6-8.

By adopting the above technical solution, the present disclosure further has the beneficial effect that the neutralization step in the present disclosure plays a role in regulating the reaction system to be neutral, thereby facilitating the subsequent treatment of the material, and stabilizing the pH value of the final product at neutrality. The acid selected in the present disclosure is conventional acid and is easy to pump and is weak in acidity, which is conducive to reducing the acidic degradation of the material, and stabilizing the viscosity of the product. And at the same time, the salt generated in the neutralization process is easy to dissolve in the water, which is conducive to the subsequent washing removal.

Further, in the step (2), the washing process is as follows: the water is added for washing, the temperature of the added water is 80-95° C., preferably 85-95° C., and more preferably 90-95° C.; and the addition volume of the water is 6-12 times of the mass of the material, and preferably 8-10 times.

By adopting the above technical solution, the present disclosure further has the beneficial effect that the function of the washing is to remove the salt and other byproducts generated in the reaction, thereby improving the product purity; and meanwhile, the reaction kettle is washed, thereby facilitating the next feeding. The selected temperature of the added water in the present disclosure can guarantee the full separation of the material and water, thereby increasing the dissolving speed of the salt, and increasing the washing efficiency. The selected water volume can thoroughly clean the reaction kettle, and the bottom of the kettle has no residue. And at the same time, the salt and other byproducts in the reaction product can be fully dissolved, and the ash content of the final product is reduced.

Further, in the step (2), the centrifugation process is as follows: the material is centrifuged at a centrifugation rotation speed of 2800-3500 r/min, and the centrifugation time is 1.5-2.5 h.

By adopting the above technical solution, the present disclosure further has the beneficial effect that the centrifugation step is to separate the material from the salt-containing waste water; and after the centrifugation, the material with the moisture content of 45-55% enters the drying step, and the salt-containing waste water enters the sewage treatment step. The centrifugation rotation speed selected in the present disclosure can efficiently separate the material from the salt-containing waste water, thereby guaranteeing the discharging smoothness. And the selected centrifugation time can guarantee the smoothness in connection between two adjacent steps, and increase the utilization rate of the equipment.

Further, in the step (2), the drying process is as follows: the material is dried at the temperature of 80-100° C., and the drying time is 1.5-2.5 h.

By adopting the above technical solution, the present disclosure further has the beneficial effect that the drying step is to remove the moisture in the centrifuged material, and the moisture of the final product is controlled to be less than 5%. The drying temperature selected in the present disclosure can guarantee the quick drying of the centrifuged material, and reduce the material degradation in the drying process. And the selected time enables the drying step to be carried out successfully, thereby guaranteeing the smoothness in connection between two adjacent steps, and increasing the utilization rate of the equipment.

Further, in the step (2), the crushing process is as follows: the material is crushed into the particle size of 0.125-0.180 mm.

By adopting the above technical solution, the present disclosure further has the beneficial effect that the crushing step is to reduce the coarseness of the material, and increase the fineness degree and stacking density of the material. The particle size selected in the present disclosure can increase the granularity and stacking density of the materials, and the product has better flowability and quality and is easy to pack.

Further, in the step (3), the mixing and stirring rotation speed is 10-70 r/min, and the time is 40-60 min.

By adopting the above technical solution, the present disclosure further has the beneficial effect that the mixing and stirring function is to mix the hydroxypropyl methyl cellulose, the starch ether, the dispersing agent and the rheological agent uniformly, thereby achieving a purpose of physical modification. The mixing and stirring rotation speed and time selected in the present disclosure can guarantee the sufficient mixing of the components to obtain the uniformly mixed product.

An application of the modified hydroxypropyl methyl cellulose for the enhanced ceramic tile adhesive in preparing the enhanced ceramic tile adhesive is provided, wherein the mass percent of the modified hydroxypropyl methyl cellulose for the enhanced ceramic tile adhesive in the enhanced ceramic tile adhesive is 0.2%-0.5%.

It can be seen from the above technical solutions that compared with the prior art, the present disclosure has the following beneficial effects.

1. In the preparation process from the raw material (cellulose) to the product (modified hydroxypropyl methyl cellulose), the present disclosure needs no surplus solvent and solvent recycling system. The water in the raw material (cellulose) and water in a small amount of liquid caustic soda are used as the solvent of the alkali, so that the use of a great amount of solvent and water in the traditional liquid phase method for preparing the modified hydroxypropyl methyl cellulose is avoided. The etherifying agent and byproduct dimethyl ether after the etherification reaction are condensed for recycling, the washing waste water enters the sewage treatment system, and the product is prepared through high-pressure reaction, so that the time of the traditional liquid phase method for preparing the modified hydroxypropyl methyl cellulose is greatly shortened, the utilization efficiency of the etherifying agent is increased, the process and equipment are simple and easy in operation, and no waste water, waste gas and waste solid is discharged, thereby being green and environment-friendly. The prepared modified hydroxypropyl methyl cellulose product is stable in quality, has a function of improving the tensile bonding strength of the ceramic tile adhesive, and can improve the use safety of the ceramic tiles after being applied to the modern ceramic tiles with large size and mass, thereby meeting the demands of the customers.

2. The present disclosure performs the one-step etherification chemical modification simultaneously on the raw material cellulose and various etherifying agents to obtain the hydroxypropyl methyl cellulose pure product, and then continuously performs the physical mixing modification on the hydroxypropyl methyl cellulose pure product through a specific amount of starch ether, dispersing agent and rheological agent to obtain the modified hydroxypropyl methyl cellulose, so that on the premise of not influencing the slip resistance of the ceramic tile adhesive, after the product is dispersed in the water, a uniform netted structure is formed, thereby further improving the water retaining capacity of the ceramic tile adhesive, generating an apparent bridging effect for the cement particles, enabling the mortar slurry to have large mechanical anchoring force, and improving the tensile bonding strength of the mortar. Compared with the prior art, the modified hydroxypropyl methyl cellulose prepared by the preparation method of the present disclosure is applied to the enhanced ceramic tile adhesive, which can improve the tensile bonding strength of the ceramic tile adhesive significantly.

3. The operating conditions of the preparation method of the present disclosure have significant differences from the existing modification method especially in the chemical modification feeding way and etherification reaction pressure. The existing method is generally to add the inhibitor dimethyl ether to inhibit the side reaction, and if the dimethyl ether is not added, the etherification efficiency is reduced, the cost is increased, and the side reaction is increased. In addition, the etherification reaction in the existing method is generally carried out under the pressure less than 2.35 MPa, and carried out at one pressure stage, which has the problem that the reaction uniformity is poor. And if the reaction is carried out in different pressure stages, the existing method may have the problems of longer reaction time, lower production efficiency and higher cost within the pressure resistance range of the existing reactor. On the premise of not adding the inhibitor dimethyl ether, by adding the granular caustic soda, the alkali concentration of the system is increased, thereby accelerating the positive reaction, inhibiting the side reaction, increasing the etherification efficiency, reducing the cost, and simplifying the recycling step of the dimethyl ether. In addition, in the present disclosure, the etherification reaction is carried out under higher pressure of 2.5 MPa. Moreover, the reaction is carried out in two pressure stages. At the first stage, the etherification reaction is carried out under the pressure of 1.8-2.0 MPa, which is more conducive to the reaction of propylene oxide, and increases the etherification efficiency of the propylene oxide, and at the second stage, the etherification reaction is carried out under the pressure of 2.3-2.5 MPa, which is more conducive to the reaction of chloromethane, and increases the etherification efficiency of the chloromethane. The reaction way in two pressure stages increases the reaction uniformity. At the same time, due to the high reaction pressure, the etherification efficiency is increased, and the reaction time of the two pressure stages is shortened, so that the total etherification reaction time is kept within 3 h, the production efficiency is increased, and the production cost is reduced. Meanwhile, the whole reaction process is carried out in the reactor with the pressure resistance of 2.8-3.5 MPa, thereby guaranteeing the reaction safety. And the modification process ensures that the preparation method is carried out successfully and efficiently, so that not only the operating steps are simplified, but also the resource and energy are saved.

### DESCRIPTION OF DRAWINGS

To more clearly describe the technical solutions in the embodiments of the present disclosure or in the prior art, the drawings required to be used in the description of the embodiments or the prior art will be simply presented below. Apparently, the drawings in the following description are merely some embodiments of the present disclosure, and for those ordinary skilled in the art, other drawings can also be obtained according to the provided drawings without contributing creative labor.

FIG. 1 is a flow chart of a process of a modified hydroxypropyl methyl cellulose for an enhanced ceramic tile adhesive of the present disclosure.

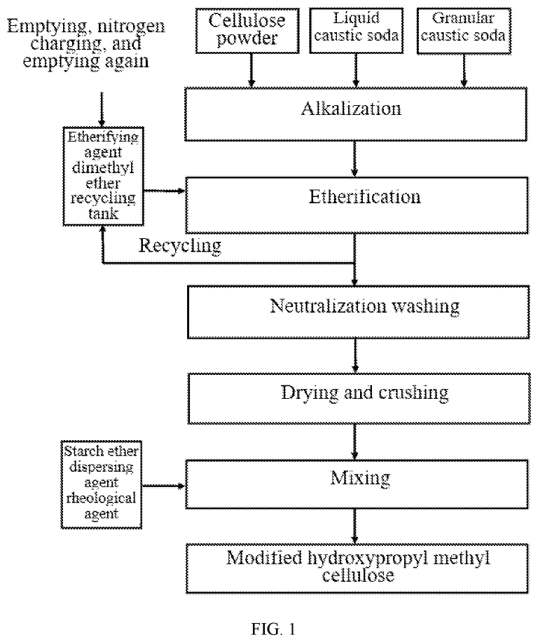

### DETAILED DESCRIPTION

Technical solutions in the embodiments of the present disclosure are described clearly and fully below. Apparently, the described embodiments are merely part of the embodiments of the present disclosure, not all of the embodiments. Based on the embodiments in the present disclosure, all other embodiments obtained by those ordinary skilled in the art without contributing creative labor will belong to the protection scope of the present disclosure.

In the following embodiments and comparative examples, the viscosity of hydroxypropyl methyl cellulose is viscosity (wet tackiness) of 2% aqueous solution measured by a B-type RVT viscosity meter at 20° C., and the viscosity of the starch ether is viscosity (dry tackiness) of 5% aqueous solution measured by a B-type LVT viscosity meter at 20° C.

### Embodiment 1

The modified hydroxypropyl methyl cellulose for the enhanced ceramic tile adhesive was prepared from the following raw materials by mass: 74 kg of hydroxypropyl methyl cellulose, 20 kg of hydroxypropyl starch (19.5% of hydroxypropyl, 5% of B-type LVT viscosity 1950 cp, and 7.5% of ash, produced by YITENG New Material Co., LTD in Shandong Province), 3 kg of anionic polyacrylamide and 3 kg of guar gum.

The hydroxypropyl cellulose was prepared from 100 kg of cotton cellulose powder (the average polymerization degree was 2663, the particle size was 0.230 mm, and the bulk density was 175 g/L), 27 kg of granular sodium hydroxide (with particle size of 0.7 mm), 63 kg of sodium hydroxide aqueous solution (with mass concentration of 50%), 74 kg of chloromethane and 16 kg of propylene oxide.

A preparation method specifically includes the following steps.

(1) Raw materials were weighed according to the above mass.

(2) The cotton cellulose powder, granular sodium hydroxide and sodium hydroxide aqueous solution liquid caustic soda were added sequentially into the reactor with a jacket and with pressure resistance of 3.0 MPa during the stirring. The reactor was emptied and was blown with nitrogen to remove oxygen, and the reactor was emptied again. The etherifying agents, that is, propylene oxide and chloromethane, were added sequentially, and temperature increased slowly to 60° C. for reaction for 0.5 h under the pressure of 1.9 MPa. Then the temperature increased slowly to 80° C. for reaction for 1.5 h under the pressure of 2.5 MPa. After the reaction was ended, temperature reduction and pressure relief were carried out, the non-reacted etherifying agents and byproducts dimethyl ether were recycled (the non-reacted etherifying agents were recycled through a three-stage condensation recycling process; at the first stage, the condensation recycling was carried out by directly relieving the pressure, and the pressure of the reactor decreased from 2.5 MPa to 1.1 MPa; at the second stage, the condensation recycling was carried out by compression, and the pressure of the reactor decreased from 1.1 MPa to 0.25 MPa; and at the third stage, the condensation recycling was carried out through vacuum and compression, and the pressure of the reactor decreased from 0.25 MPa to −0.1 MPa). Acetic acid was added into the reactor to regulate the pH value of the material to be 6.5. Then hot water at 90° C. with the amount being 8 times of the mass of the material was added into the reactor for washing. Centrifugation was carried out for 2 h at the rotation speed of 3000 r/min; then the drying was carried out for 2 h at 90° C. And the crushing was carried out to obtain the particle size of 0.15 mm to obtain the hydroxypropyl methyl cellulose pure product.

(3) The hydroxypropyl methyl cellulose pure product prepared in the step (2), the hydroxypropyl starch, anionic polyacrylamide and guar gum were added into a mixing machine for mixing and stirring for 50 min at a rotation speed of 50 r/min to obtain the modified hydroxypropyl methyl cellulose for the enhanced ceramic tile adhesive.

### Embodiment 2

The modified hydroxypropyl methyl cellulose for the enhanced ceramic tile adhesive was prepared from the following raw materials by mass: 66 kg of hydroxypropyl methyl cellulose, 30 kg of hydroxypropyl starch (19.5% of hydroxypropyl, 5% of B-type LVT viscosity 1950 cp, and 7.5% of ash, produced by YITENG New Material Co., LTD in Shandong Province), 2 kg of nonionic polyacrylamide and 2 kg of Arabic gum.

The hydroxypropyl cellulose was prepared from 100 kg of wood cellulose powder (the average polymerization degree was 2880, the particle size was 0.230 mm, and the bulk density was 175 g/L), 34 kg of granular sodium hydroxide (with particle size of 0.7 mm), 51 kg of sodium hydroxide aqueous solution (with mass concentration of 50%), 79 kg of chloromethane and 12 kg of propylene oxide.

A preparation method specifically includes the following steps.

(1) Raw materials were weighed according to the above mass.

(2) The wood cellulose powder, granular sodium hydroxide and sodium hydroxide aqueous solution liquid caustic soda were added sequentially into the reactor with a jacket and with pressure resistance of 3.0 MPa during the stirring. The reactor was emptied and was blown with nitrogen to remove oxygen, and the air in the reactor was emptied again. The etherifying agents, that is, propylene oxide and chloromethane, were added sequentially. And temperature increased slowly to 60° C. for reaction for 0.5 h under the pressure of 1.9 MPa. Then the temperature increased slowly to 80° C. for reaction for 1.5 h under the pressure of 2.5 MPa. After the reaction was ended, temperature reduction and pressure relief were carried out, the non-reacted etherifying agents and byproducts dimethyl ether were recycled (the non-reacted etherifying agents were recycled through a three-stage condensation recycling process; at the first stage, the condensation recycling was carried out by directly relieving the pressure, and the pressure of the reactor decreased from 2.5 MPa to 1.1 MPa; at the second stage, the condensation recycling was carried out by compression, and the pressure of the reactor decreased from 1.1 MPa to 0.25 MPa; and at the third stage, the condensation recycling was carried out through vacuum and compression, and the pressure of the reactor decreased from 0.25 MPa to −0.1 MPa). Hydrochloric acid was added into the reactor to regulate the pH value of the material to be 6.5. Then hot water at 90° C. with the amount being 8 times of the mass of the material was added into the reactor for washing. Centrifugation was carried out for 2.5 h at the rotation speed of 2800 r/min. Then the drying was carried out for 2.5 h at 80° C. And the crushing was carried out to obtain the particle size of 0.125 mm to obtain the hydroxypropyl methyl cellulose pure product.

(3) The hydroxypropyl methyl cellulose pure product prepared in the step (2), the hydroxypropyl starch, anionic polyacrylamide and guar gum were added into a mixing machine for mixing and stirring for 50 min at a rotation speed of 10 r/min to obtain the modified hydroxypropyl methyl cellulose for the enhanced ceramic tile adhesive.

### Embodiment 3

The modified hydroxypropyl methyl cellulose for the enhanced ceramic tile adhesive was prepared from the following raw materials by mass: 71 kg of hydroxypropyl methyl cellulose, 25 kg of hydroxypropyl starch (19.5% of hydroxypropyl, 5% of B-type LVT viscosity 1950 cp, and 7.5% of ash, produced by YITENG New Material Co., LTD in Shandong Province), 2 kg of polyvinyl alcohol and 2 kg of carrageenan.

The hydroxypropyl cellulose was prepared from 20 kg of bamboo cellulose powder (the average polymerization degree was 1060, the particle size was 0.18 mm, and the bulk density was 150 g/L), 60 kg of wood cellulose powder (the average polymerization degree was 2530, the particle size was 0.18 mm, and the bulk density was 150 g/L), 20 kg of cotton cellulose powder (the average polymerization degree was 5010, the particle size was 0.18 mm, and the bulk density was 150 g/L), 65 kg of granular potassium hydroxide (with particle size of 0.3 mm), 100 kg of potassium hydroxide aqueous solution (with mass concentration of 40%), 167 kg of chloromethane and 65 kg of propylene oxide.

A preparation method specifically includes the following steps.

(1) Raw materials were weighed according to the above mass.

(2) The bamboo cellulose powder, the wood cellulose powder, the cotton cellulose powder, the granular potassium hydroxide and potassium hydroxide aqueous solution liquid caustic soda were added into the reactor with a jacket and with pressure resistance of 3.0 MPa during the stirring. The reactor was emptied and was blown with nitrogen to remove oxygen, and the reactor was emptied again. The etherifying agents, that is, propylene oxide and chloromethane, were added sequentially. And temperature increased slowly to 60° C. for reaction for 1.5 h under the pressure of 2.0 MPa. Then the temperature increased slowly to 80° C. for reaction for 0.5 h under the pressure of 2.3 MPa. After the reaction was ended, temperature reduction and pressure relief were carried out, the non-reacted etherifying agents and byproducts dimethyl ether were recycled (the non-reacted etherifying agents were recycled through a three-stage condensation recycling process; at the first stage, the condensation recycling was carried out by directly relieving the pressure, and the pressure of the reactor decreased from 2.3 MPa to 0.75 MPa; at the second stage, the condensation recycling was carried out by compression, and the pressure of the reactor decreased from 0.75 MPa to 0.1 MPa; and at the third stage, the condensation recycling was carried out through vacuum and compression, and the pressure of the reactor decreased from 0.1 MPa to −0.08 MPa). Hydrochloric acid was added into the reactor to regulate the pH value of the material to be 6.5. Then hot water at 90° C. with the amount being 8 times of the mass of the material was added into the reactor for washing. Centrifugation was carried out for 1.5 h at the rotation speed of 3500 r/min. Then the drying was carried out for 1.5 h at 80° C. And the crushing was carried out to obtain the particle size of 0.180 mm to obtain the hydroxypropyl methyl cellulose pure product.

(3) The hydroxypropyl methyl cellulose pure product prepared in the step (2), the hydroxypropyl starch, the polyvinyl alcohol and the carrageenan were added into a mixing machine for mixing and stirring for 45 min at a rotation speed of 70 r/min to obtain the modified hydroxypropyl methyl cellulose for the enhanced ceramic tile adhesive.

### Embodiment 4

The modified hydroxypropyl methyl cellulose for the enhanced ceramic tile adhesive was prepared from the following raw materials by mass: 78 kg of hydroxypropyl methyl cellulose, 20 kg of hydroxypropyl starch (19.5% of hydroxypropyl, 5% of B-type LVT viscosity 1950 cp, and 7.5% of ash, produced by YITENG New Material Co., LTD in Shandong Province), 1 kg of polyoxyethylene and 1 kg of xanthan gum.

The hydroxypropyl cellulose was prepared from 70 kg of straw cellulose powder (the average polymerization degree was 500, the particle size was 0.30 mm, and the bulk density was 200 g/L), 30 kg of cotton cellulose powder (the average polymerization degree was 8000, the particle size was 0.30 mm, and the bulk density was 200 g/L), 50 kg of granular potassium hydroxide (with particle size of 2.0 mm), 80 kg of potassium hydroxide aqueous solution (with mass concentration of 60%), 156 kg of chloromethane and 120 kg of propylene oxide.

A preparation method specifically includes the following steps.

(1) Raw materials were weighed according to the above mass.

(2) The straw cellulose powder, the cotton cellulose powder, the granular potassium hydroxide and potassium hydroxide aqueous solution liquid caustic soda were added into the reactor with a jacket and with pressure resistance of 3.0 MPa during the stirring. The reactor was emptied and was blown with nitrogen to remove oxygen, and the reactor was emptied again. The etherifying agents, that is, propylene oxide and chloromethane, were added sequentially. And temperature increased slowly to 60° C. for reaction for 1 h under the pressure of 1.9 MPa. Then the temperature increased slowly to 80° C. for reaction for 1 h under the pressure of 2.3 MPa. After the reaction was ended, temperature reduction and pressure relief were carried out, the non-reacted etherifying agents and byproducts dimethyl ether were recycled (the non-reacted etherifying agents were recycled through a three-stage condensation recycling process; at the first stage, the condensation recycling was carried out by directly relieving the pressure, and the pressure of the reactor decreased from 2.3 MPa to 0.75 MPa; at the second stage, the condensation recycling was carried out by compression, and the pressure of the reactor decreased from 0.75 MPa to 0.1 MPa; and at the third stage, the condensation recycling was carried out through vacuum and compression, and the pressure of the reactor decreased from 0.1 MPa to −0.08 MPa). Hydrochloric acid was added into the reactor to regulate the pH value of the material to be 6.5. Then hot water at 90° C. with the amount being 8 times of the mass of the material was added into the reactor for washing. Centrifugation was carried out for 2.5 h at the rotation speed of 3500 r/min. Then the drying was carried out for 2.5 h at 100° C. And the crushing was carried out to obtain the particle size of 0.180 mm to obtain the hydroxypropyl methyl cellulose pure product.

(3) The hydroxypropyl methyl cellulose pure product prepared in the step (2), the hydroxypropyl starch, the polyoxyethylene and the xanthan gum were added into a mixing machine for mixing and stirring for 45 min at a rotation speed of 70 r/min to obtain the modified hydroxypropyl methyl cellulose for the enhanced ceramic tile adhesive.

### Comparative Example 1

The modified hydroxypropyl methyl cellulose for the enhanced ceramic tile adhesive was prepared from the following raw materials by mass: 74 kg of hydroxypropyl methyl cellulose, 20 kg of hydroxypropyl starch (19.5% of hydroxypropyl, 5% of B-type LVT viscosity 1950 cp, and 7.5% of ash, produced by YITENG New Material Co., LTD in Shandong Province), 3 kg of anionic polyacrylamide and 3 kg of guar gum.

The hydroxypropyl cellulose was prepared from 100 kg of cotton cellulose powder (the average polymerization degree was 2537, the particle size was 0.230 mm, and the bulk density was 175 g/L), 18 kg of granular sodium hydroxide (with particle size of 0.7 mm), 41 kg of sodium hydroxide aqueous solution (with mass concentration of 50%), 57 kg of chloromethane and 5 kg of propylene oxide.

A preparation method specifically includes the following steps.

(1) Raw materials were weighed according to the above mass.

(2) The cotton cellulose powder, granular sodium hydroxide and sodium hydroxide aqueous solution liquid caustic soda were added into the reactor with a jacket and with pressure resistance of 3.0 MPa during the stirring. The reactor was emptied and was blown with nitrogen to remove oxygen, and the air in the reactor was emptied again. The etherifying agents, that is, propylene oxide and chloromethane, were added sequentially. And temperature increased slowly to 60° C. for reaction for 1 h under the pressure of 1.8 MPa. Then the temperature increased slowly to 80° C. for reaction for 1 h under the pressure of 2.3 MPa. After the reaction was ended, temperature reduction and pressure relief were carried out. The non-reacted etherifying agents and byproducts dimethyl ether were recycled (the non-reacted etherifying agents were recycled through a three-stage condensation recycling process; at the first stage, the condensation recycling was carried out by directly relieving the pressure, and the pressure of the reactor decreased from 2.3 MPa to 1.1 MPa; at the second stage, the condensation recycling was carried out by compression, and the pressure of the reactor decreased from 1.1 MPa to 0.25 MPa; and at the third stage, the condensation recycling was carried out through vacuum and compression, and the pressure of the reactor decreased from 0.25 MPa to −0.1 MPa). Acetic acid was added into the reactor to regulate the pH value of the material to be 6.5. Then hot water at 90° C. with an amount being 8 times of the mass of the material was added into the reactor for washing. Centrifugation was carried out for 2 h at a rotation speed of 3000 r/min. Then the drying was carried out for 2 h at 90° C. And the crushing was carried out to obtain the particle size of 0.15 mm to obtain the hydroxypropyl methyl cellulose pure product.

(3) The hydroxypropyl methyl cellulose pure product prepared in the step (2), the hydroxypropyl starch, anionic polyacrylamide and guar gum were added into a mixing machine for mixing and stirring for 60 min at a rotation speed of 50 r/min to obtain the modified hydroxypropyl methyl cellulose for the enhanced ceramic tile adhesive.

### Comparative Example 2

The modified hydroxypropyl methyl cellulose for the enhanced ceramic tile adhesive was prepared from the following raw materials by mass: 66 kg of hydroxypropyl methyl cellulose, 30 kg of hydroxypropyl starch (19.5% of hydroxypropyl, 5% of B-type LVT viscosity 1950 cp, and 7.5% of ash, produced by YITENG New Material Co., LTD in Shandong Province), 2 kg of nonionic polyacrylamide and 2 kg of Arabic gum.

The hydroxypropyl cellulose was prepared from 100 kg of cotton cellulose powder (the average polymerization degree was 2739, the particle size was 0.230 mm, and the bulk density was 175 g/L), 18 kg of granular sodium hydroxide (with particle size of 0.7 mm), 50 kg of sodium hydroxide aqueous solution (with mass concentration of 50%), 60 kg of chloromethane and 8 kg of propylene oxide.

A preparation method specifically includes the following steps.

(1) Raw materials were weighed according to the above mass.

(2) The cotton cellulose powder, granular sodium hydroxide and sodium hydroxide aqueous solution liquid caustic soda were added into the reactor with a jacket and with pressure resistance of 3.0 MPa during the stirring. The reactor was emptied and was blown with nitrogen to remove oxygen, and the reactor was emptied again. The etherifying agents, that is, propylene oxide and chloromethane, were added sequentially. And temperature increased slowly to 60° C. for reaction for 1 h under the pressure of 1.9 MPa. Then the temperature increased slowly to 80° C. for reaction for 1 h under the pressure of 2.3 MPa. After the reaction was ended, temperature reduction and pressure relief were carried out. The non-reacted etherifying agents and byproducts dimethyl ether were recycled (the non-reacted etherifying agents were recycled through a three-stage condensation recycling process; at the first stage, the condensation recycling was carried out by directly relieving the pressure, and the pressure of the reactor decreased from 2.3 MPa to 0.75 MPa; at the second stage, the condensation recycling was carried out by compression, and the pressure of the reactor decreased from 0.75 MPa to 0.1 MPa; and at the third stage, the condensation recycling was carried out through vacuum and compression, and the pressure of the reactor decreased from 0.1 MPa to −0.08 MPa). Acetic acid was added into the reactor to regulate the pH value of the material to be 6.5. Then hot water at 90° C. with the amount being 8 times of the mass of the material was added into the reactor for washing. Centrifugation was carried out for 2 h at the rotation speed of 3000 r/min. Then the drying was carried out for 2 h at 90° C. And the crushing was carried out to obtain the particle size of 0.15 mm to obtain the hydroxypropyl methyl cellulose pure product.

(3) The hydroxypropyl methyl cellulose pure product prepared in the step (2), the hydroxypropyl starch, nonionic polyacrylamide and Arabic gum were added into a mixing machine for mixing and stirring for 50 min at a rotation speed of 50 r/min to obtain the modified hydroxypropyl methyl cellulose for the enhanced ceramic tile adhesive.

### Comparative Example 3

The modified hydroxypropyl methyl cellulose for the enhanced ceramic tile adhesive was prepared from the following raw materials by mass: 71 kg of hydroxypropyl methyl cellulose, 25 kg of hydroxypropyl starch (19.5% of hydroxypropyl, 5% of B-type LVT viscosity 1950 cp, and 7.5% of ash, produced by YITENG New Material Co., LTD in Shandong Province), 2 kg of polyvinyl alcohol and 2 kg of carrageenan.

The hydroxypropyl cellulose was prepared from 100 kg of cotton cellulose powder (the average polymerization degree was 2659, the particle size was 0.230 mm, and the bulk density was 175 g/L), 17 kg of granular sodium hydroxide (with particle size of 0.7 mm), 68 kg of sodium hydroxide aqueous solution (with mass concentration of 50%), 64 kg of chloromethane and 16 kg of propylene oxide.

A preparation method specifically includes the following steps.

(1) Raw materials were weighed according to the above mass.

(2) The cotton cellulose powder, granular sodium hydroxide and sodium hydroxide aqueous solution liquid caustic soda were added into the reactor with a jacket and with pressure resistance of 3.0 MPa during the stirring. The reactor was emptied and was blown with nitrogen to remove oxygen, and the reactor was emptied again. The etherifying agents, that is, propylene oxide and chloromethane were added sequentially. And temperature increased slowly to 60° C. for reaction for 1.5 h under the pressure of 1.9 MPa. Then the temperature increased slowly to 80° C. for reaction for 0.5 h under the pressure of 2.4 MPa. After the reaction was ended, temperature reduction and pressure relief were carried out. The non-reacted etherifying agents and byproducts dimethyl ether were recycled (the non-reacted etherifying agents were recycled through a three-stage condensation recycling process; at the first stage, the condensation recycling was carried out by directly relieving the pressure, and the pressure of the reactor decreased from 2.4 MPa to 1.1 MPa; at the second stage, the condensation recycling was carried out by compression, and the pressure of the reactor decreased from 1.1 MPa to 0.25 MPa; and at the third stage, the condensation recycling was carried out through vacuum and compression, and the pressure of the reactor decreased from 0.25 MPa to −0.1 MPa). Acetic acid was added into the reactor to regulate the pH value of the material to be 6.5. Then hot water at 90° C. with the amount being 8 times of the mass of the material was added into the reactor for washing. Centrifugation was carried out for 2 h at the rotation speed of 3000 r/min. Then the drying was carried out for 2 h at 90° C. And the crushing was carried out to obtain the particle size of 0.15 mm to obtain the hydroxypropyl methyl cellulose pure product.

(3) The hydroxypropyl methyl cellulose pure product prepared in the step (2), the hydroxypropyl starch, polyvinyl alcohol and carrageenan were added into a mixing machine for mixing and stirring for 50 min at a rotation speed of 50 r/min to obtain the modified hydroxypropyl methyl cellulose for the enhanced ceramic tile adhesive.

### Comparative Example 4

The modified hydroxypropyl methyl cellulose for the enhanced ceramic tile adhesive was prepared from the following raw materials by mass: 78 kg of hydroxypropyl methyl cellulose, 20 kg of hydroxypropyl starch (19.5% of hydroxypropyl, 5% of B-type LVT viscosity 1950 cp, and 7.5% of ash, produced by YITENG New Material Co., LTD in Shandong Province), 1 kg of polyoxyethylene and 1 kg of xanthan gum.

The hydroxypropyl cellulose was prepared from 100 kg of cotton cellulose powder (the average polymerization degree was 2452, the particle size was 0.230 mm, and the bulk density was 175 g/L), 43 kg of granular sodium hydroxide (with particle size of 0.7 mm), 65 kg of sodium hydroxide aqueous solution (with mass concentration of 50%), 96 kg of chloromethane and 43 kg of propylene oxide.

A preparation method specifically includes the following steps.

(1) Raw materials were weighed according to the above mass.

(2) The cotton cellulose powder, granular sodium hydroxide and sodium hydroxide aqueous solution liquid caustic soda were added into the reactor with a jacket and with pressure resistance of 3.0 MPa during the stirring. The reactor was emptied and was blown with nitrogen to remove oxygen, and the reactor was emptied again. The etherifying agents, that is, propylene oxide and chloromethane, were added sequentially. And temperature increased slowly to 60° C. for reaction for 1 h under the pressure of 1.9 MPa. Then the temperature increased slowly to 80° C. for reaction for 1 h under the pressure of 2.5 MPa. After the reaction was ended, temperature reduction and pressure relief were carried out. The non-reacted etherifying agents and byproducts dimethyl ether were recycled (the non-reacted etherifying agents were recycled through a three-stage condensation recycling process; at the first stage, the condensation recycling was carried out by directly relieving the pressure, and the pressure of the reactor decreased from 2.5 MPa to 1.1 MPa; at the second stage, the condensation recycling was carried out by compression, and the pressure of the reactor decreased from 1.1 MPa to 0.25 MPa; and at the third stage, the condensation recycling was carried out through vacuum and compression, and the pressure of the reactor decreased from 0.25 MPa to −0.1 MPa). Acetic acid was added into the reactor to regulate the pH value of the material to be 6.5. Then hot water at 90° C. with the amount being 8 times of the mass of the material was added into the reactor for washing. Centrifugation was carried out for 2 h at the rotation speed of 3000 r/min. Then the drying was carried out for 2 h at 90° C. And the crushing was carried out to obtain the particle size of 0.15 mm to obtain the hydroxypropyl methyl cellulose pure product.

(3) The hydroxypropyl methyl cellulose pure product prepared in the step (2), the hydroxypropyl starch, the polyoxyethylene and the xanthan gum were added into a mixing machine for mixing and stirring for 40 min at a rotation speed of 50 r/min to obtain the modified hydroxypropyl methyl cellulose for the enhanced ceramic tile adhesive.

Performance Test

1. Methoxyl content, hydroxypropoxy content, 2% B-type RVT viscosity and ash content of the hydroxypropyl methyl cellulose pure product prepared in the step (2) in the embodiments 1-4 and comparative examples 1-4 were determined respectively, and the determination results were shown in Table 1.

TABLE 1
Performance test results of hydroxypropyl methyl cellulose pure product in
embodiments 1-4 and comparative examples 1-4

| | | | | 2% | |
|---|---|---|---|---|---|
| | | | | B-type | |
| | Methoxyl | | | RVT | Ash |
| | content | Hydroxypropoxy | Methoxyl + hydroxypropoxy | viscosity | content |
| Item | (%) | content (%) | content (%) | (cp) | (%) |
| Embodiment 1 | 28.36 | 11.40 | 39.76 | 62362 | 4.5 |
| Embodiment 2 | 30.52 | 9.04 | 39.56 | 73385 | 4.4 |
| Embodiment 3 | 25.71 | 18.96 | 44.67 | 67973 | 4.5 |
| Embodiment 4 | 22.52 | 25.02 | 47.54 | 63067 | 4.6 |
| Comparative | 20.81 | 4.47 | 25.28 | 62187 | 4.3 |
| example 1 | | | | | |
| Comparative | 22.83 | 6.59 | 29.42 | 73518 | 4.3 |
| example 2 | | | | | |
| Comparative | 24.66 | 12.16 | 36.82 | 68235 | 4.4 |
| example 3 | | | | | |
| Comparative | 31.23 | 26.50 | 57.73 | 63858 | 4.5 |
| example 4 | | | | | |

It may be seen from Table 1 that the hydroxypropyl methyl cellulose prepared in the embodiments 1-4 has higher total content of methoxyl and hydroxypropoxy, and the total content is ranged from 3800 to 480%, which is apparent higher than the total content (in a range of 250%-37%) of the methoxyl and hydroxypropoxy of the hydroxypropyl methyl cellulose prepared in the comparative examples 1-3, but far less than the total content (about 580%) of the methoxyl and hydroxypropoxy of the hydroxypropyl methyl cellulose prepared in the comparative example 4. The hydroxypropyl methyl cellulose prepared in the embodiment 2 has higher methoxyl content and lower hydroxypropoxy content, but the hydroxypropyl methyl cellulose prepared in the embodiment 4 has lower methoxyl content and higher hydroxypropoxy content. In addition, the embodiments 1-4 and the comparative examples 1-4 all have similar viscosity range and ash content.

2. A small amount of modified hydroxypropyl methyl cellulose prepared in the embodiments 1-4 and comparative examples 1-4 was measured respectively for preparing the enhanced ceramic tile adhesive. A preparation method includes the following steps. The components were fed into the mixing machine for uniform mixing according to the components shown in Table 2, and water with the amount that was 250% of the total weight of the components was added. The stirring was carried out according to stirring equipment and stirring methods stipulated in the Standard JC/T547-2005 Adhesives For Ceramic Wall And Floor Tiles. And then the test on various performance (slip, tensile bonding strength, tensile bonding strength after soaking in water, tensile bonding strength after hot aging, tensile bonding strength after freezing-melting cycling and tensile bonding strength after standing in air for 30 min) was carried out. And the test results were shown in Table 3.

TABLE 2
Ceramic tile adhesive formulas of embodiments 1-4 and comparative examples 1-4

| | | | | Butadiene- | Water | | Modified |
|---|---|---|---|---|---|---|---|
| | 42.5 | Fine | Triple | styrene | reducing | Calcium | hydroxypropyl |
| | cement | sand | superphosphate | rubber | agent | formate | methyl |
| Item | (g) | (g) | (g) | powder (g) | (g) | (g) | cellulose (g) |
| Embodiments | 360 | 582 | 20 | 30 | 1 | 3 | 4 |
| 1-4 | | | | | | | |
| Comparative | | | | | | | |
| examples | | | | | | | |
| 1-4 | | | | | | | |

TABLE 3
Performance test of ceramic tile adhesive of embodiments 1-4 and comparative examples 1-4

| | | | Tensile bonding | | Tensile bonding | Tensile bonding |
|---|---|---|---|---|---|---|
| | | | strength after | Tensile bonding | strength after | strength after |
| | Slip | Tensile bonding | soaking in | strength after | freezing-melting | standing in air |
| Item | (mm) | strength (MPa) | water (MPa) | hot aging (MPa) | cycling (MPa) | for 30 min (MPa) |
| Index | ≤0.5 | ≥1.0 | | | | ≥0.5 |
| Embodiment 1 | 0.2 | 1.508 | 1.132 | 1.316 | 1.268 | 1.081 |
| Embodiment 2 | 0.1 | 1.632 | 1.243 | 1.409 | 1.348 | 1.139 |
| Embodiment 3 | 0.1 | 1.581 | 1.197 | 1.368 | 1.302 | 1.113 |
| Embodiment 4 | 0.1 | 1.553 | 1.161 | 1.337 | 1.278 | 1.027 |
| Comparative | 0.4 | 1.027 | 0.643 | 0.819 | 0.755 | 0.526 |
| example 1 | | | | | | |
| Comparative | 0.3 | 1.116 | 0.739 | 0.907 | 0.843 | 0.627 |
| example 2 | | | | | | |
| Comparative | 0.3 | 1.209 | 0.845 | 1.086 | 0.937 | 0.695 |
| example 3 | | | | | | |
| Comparative | 0.2 | 1.015 | 0.631 | 0.854 | 0.762 | 0.432 |
| example 4 | | | | | | |

It can be seen from Table 3 that the modified hydroxypropyl methyl cellulose prepared in the embodiments 1-4 of the present disclosure has an effect for improving the tensile bonding strength of the ceramic tile adhesive, wherein the tensile bonding strength and the tensile bonding strength after soaking in water, hot aging and freezing-melting cycling all can meet the requirement of the index ≥1.0 MPa, and meet the requirement of the ceramic tile adhesive that the slip resistance ≤0.5 mm and the tensile bonding strength after standing in air for 30 min≥0.5 MPa and all are better than the corresponding indexes of the comparative examples 1-4. The embodiment 2 is the optimum embodiment.

The above tests indicate that the present disclosure is simple in process and equipment, easy in operation, free from emission of waste water, waste gas and waste solids, and the modified hydroxypropyl methyl cellulose product prepared in the present disclosure is stable in quality, has a function of improving the tensile bonding strength of the ceramic tile adhesive, is applied to modern ceramic tiles with large sizes and large masses, and can improve the use safety of the ceramic tiles significantly, thereby meeting the requirements of the customers.

The above description of the disclosed embodiments enables those skilled in the art to realize or use the present disclosure. Many modifications made to these embodiments will be apparent to those skilled in the art. General principles defined herein can be realized in other embodiments without departing from the spirit or scope of the present disclosure. Therefore, the present disclosure will not be limited to these embodiments shown herein, but will conform to the widest scope consistent with the principles and novel features disclosed herein.

What is claimed is:

1. A modified hydroxypropyl methyl cellulose for an enhanced ceramic tile adhesive, prepared from the following raw materials by mass percent: 54%-94% of hydroxypropyl methyl cellulose, 5%-40% of starch ether, 0.5%-3% of dispersing agent and 0.5%-3% of rheological agent, wherein
the hydroxypropyl methyl cellulose is prepared from cellulose powder, granular caustic soda, liquid caustic soda, chloromethane and propylene oxide in a mass ratio of 1:(0.01-1.0):(0.02-2.1):(0.50-2.0):(0.01-1.5).

2. The modified hydroxypropyl methyl cellulose for the enhanced ceramic tile adhesive of claim 1, wherein the starch ether is any one or mixture of more of monobasic starch ether, binary starch ether and ternary starch ether.

3. The modified hydroxypropyl methyl cellulose for the enhanced ceramic tile adhesive of claim 1, wherein the dispersing agent is any one or mixture of more of polyacrylamide, polyvinyl alcohol and polyethylene oxide.

4. The modified hydroxypropyl methyl cellulose for the enhanced ceramic tile adhesive of claim 1, wherein the rheological agent is any one or mixture of more of guar gum, Arabic gum, carrageenan and xanthan gum.

5. The modified hydroxypropyl methyl cellulose for the enhanced ceramic tile adhesive of claim 1, wherein the cellulose powder is any one or mixture of more of cotton cellulose, wood cellulose, bamboo cellulose and straw cellulose;
a polymerization degree of the cellulose powder is 500-8000;
a particle size of the cellulose powder is 0.18-0.30 mm; and
a bulk density of the cellulose powder is 150-200 g/L.

6. The modified hydroxypropyl methyl cellulose for the enhanced ceramic tile adhesive of claim 1, wherein the granular caustic soda is granular alkali metal hydroxide;
the alkali metal hydroxide is sodium hydroxide and/or potassium hydroxide;
a particle size of the granular caustic soda is 0.3-2.0 mm.

7. The modified hydroxypropyl methyl cellulose for the enhanced ceramic tile adhesive of claim 1, wherein the liquid caustic soda is an aqueous solution of alkali metal hydroxide;
the alkali metal hydroxide is sodium hydroxide and/or potassium hydroxide;
a mass concentration of the alkali metal hydroxide in the liquid caustic soda is 40%-60%.

8. A preparation method of the modified hydroxypropyl methyl cellulose for the enhanced ceramic tile adhesive, specifically comprising the following steps:
(1) weighing the raw materials according to a mass ratio of the modified hydroxypropyl methyl cellulose for the enhanced ceramic tile adhesive of claim 1;
(2) mixing the cellulose powder, the granular caustic soda, the liquid caustic soda, the chloromethane and the propylene oxide, and carrying out etherification reaction, neutralization, washing, centrifugation, drying and crushing to obtain the hydroxypropyl methyl cellulose; and
(3) mixing and stirring the hydroxypropyl methyl cellulose, the starch ether, the dispersing agent and the rheological agent to obtain the modified hydroxypropyl methyl cellulose for the enhanced ceramic tile adhesive.

9. The preparation method of the modified hydroxypropyl methyl cellulose for the enhanced ceramic tile adhesive of claim 8, wherein in the step (2), the etherification reaction comprises a first-stage etherification reaction and a second-stage etherification reaction;
the first-stage etherification reaction is carried out under the pressure of 1.8-2.0 MPa and at the temperature of 55-65° C., and the reaction time is 0.5-1.5 h;
in the step (2), the second-stage etherification reaction is carried out under the pressure of 2.3-2.5 MPa and at the temperature of 75-85° C., and the reaction time is 0.5-1.5 h; and
in the step (3), the mixing and stirring rotation speed is 10-70 r/min, and the time is 40-60 min.

10. An application of the modified hydroxypropyl methyl cellulose for the enhanced ceramic tile adhesive of claim 1 in preparing the enhanced ceramic tile adhesive, wherein a mass percent of the modified hydroxypropyl methyl cellulose for the enhanced ceramic tile adhesive in the enhanced ceramic tile adhesive is 0.2%-0.5%.
